(19) United States
(12) Patent Application Publication
(10) Pub. No.: US 2010/0090071 A1
(43) Pub. Date: Apr. 15, 2010

(54) PAINT STAND FOR MOTORCYCLE GAS TANKS

(76) Inventors: Phillip Orin Gothard, Freeport, IL (US); Mark Allen Spittler, Freeport, IL (US)

Correspondence Address: KEITH FRANTZ, 401 WEST STATE STREET, SUITE 200, ROCKFORD, IL, 61101, US

(21) Appl. No.: 12/176,257

(22) Filed: Jul. 18, 2008

Related U.S. Application Data
(60) Provisional application No. 60/950,340, filed on Jul. 18, 2007.

(51) Int. Cl. F16M 11/24

(52) U.S. Cl. 248/129; 248/157

(57) ABSTRACT

A motorcycle gas tank paint stand includes (i) a bung plug adapter to releasably connect to the inside wall surrounding the gas fill access opening of the gas tank, and to optionally engage the outer lip surrounding the gas fill access opening, without obscuring the exterior surface of the gas tank to be painted, (ii) a first rotary device carrying the bung plug adapter for rotating the bung plug adapter through 360 degrees about a non-horizontal axis, and a corresponding position-locking mechanism to selectively secure the bung plug adapter and gas tank in a desired angular position about the non-horizontal axis, (iii) a second rotary device carrying the first rotary device for rotating the bung plug adapter through 360 degrees about a horizontal axis, and a corresponding position-locking mechanism to selectively secure the bung plug adapter and gas tank in a desired angular position about the horizontal axis, and (iv) an optional linear translating device carrying the second rotary device shaft for effecting selective height adjustment of the bung plug adapter and gas tank.

### CROSS-REFERENCES TO RELATED APPLICATIONS

This application claims priority to U.S. Provisional Patent Application Ser. No. 60/950,340, filed Jul. 18, 2007.

### INCORPORATION-BY-REFERENCE OF MATERIAL SUBMITTED ON A COMPACT DISC

Not Applicable.

### STATEMENT REGARDING FEDERALLY SPONSORED RESEARCH OR DEVELOPMENT

Not Applicable.

### TECHNICAL FIELD

This invention relates generally to paint stands for motorcycle gas tanks

More particularly, the invention relates to a stand that is configured to hold and rotate most types of motorcycle gas tanks for height adjustment, positioning through 360 degrees about a horizontal axis, and positioning through 360 degrees about a second axis that rotates about the horizontal axis, for presenting the entire tank to the painter at a convenient position and orientation, thereby promoting ease of painting the tank uniformly, or otherwise, as desired. The paint stand is also useful to hold, rotate and position a motorcycle gas tank for other purposes, including but not limited to, application of decals and other decorative elements, as well as for tank maintenance and repair.

### BACKGROUND OF THE INVENTION

Painting motorcycle gas tanks presents certain difficulties. On older motorcycles, the bottom of the tank typically cannot be seen when installed on the motorcycle. Thus, other than for a coat of primer or base color, the bottom of the tank is often not painted. The upper, normally visible part of the tank is typically painted by setting the tank onto a workbench or paint table so that the painter can walk around the tank, or carefully rotate the tank, to apply the desired paint. This can be an awkward procedure, and can hinder the painter in application of uniform paint on the visible part of the tank.

On many newer motorcycles, portions of the bottom of the gas tank are visible when installed on the motorcycle. Painting such gas tanks uniformly is, thus, further complicated by the need to paint at least a part of the bottom of the tank. This can require, for example, the painter to paint the top of the gas tank while the tank setting on its bottom on a workbench or paint table, letting this paint dry, and then turning the tank onto its side or top to paint the bottom of the tank, typically after taping portions of the already painted part of the tank, or otherwise taking care to avoid over-spray onto the previously painted part of the tank. Various other methods are used for painting motorcycle gas tanks. However, all current methods suffer from similar and other known drawbacks and disadvantages that hinder the application of uniform, or otherwise, as desired, paint to motorcycle gas tanks

The present invention addresses the above-described drawbacks and disadvantages associated with current methods for painting motorcycle gas tanks.

### OBJECTIVES OF THE INVENTION

The principle objective of the invention is to a provide new, improved and unique paint stand for motorcycle gas tanks

A detailed objective of the invention is to achieve the foregoing by providing a paint stand that is configured to hold and rotate a motorcycle gas tank for selective height adjustment, selective positioning through 360 degrees about a horizontal axis, and selective positioning through 360 degrees about a second axis that rotates about the horizontal axis, for presenting the entire gas tank to a painter at a convenient position and orientation. By achieving these and other objectives and advantages, the invention promotes ease of painting the tank uniformly, or otherwise, as desired, and in general, promotes improved workmanship in relation to painting motorcycle gas tanks

Another detailed objective of the invention is to provide a paint stand of the above-described type that is adaptable for use with most types of motorcycle gas tanks.

Another detailed objective of the invention is to provide a paint stand of the above-described type that enhances ease of application of decals to a motorcycle gas tank, and that can be used for other decorative and tank repair purposes.

These and other objectives and advantages of the invention will become more apparent from the following detailed description when taken in conjunction with the accompanying drawings.

### SUMMARY OF THE INVENTION

Briefly, a motorcycle gas tank paint stand, according to the invention, includes (i) a bung holder (alternately referred to herein as a bung plug adapter) configured to releasably connect to the cylindrical inside diameter wall surrounding the gas fill access opening of the gas tank (the opening through which the tank is filled with gas), and to optionally engage the top outer lip surrounding the gas fill access opening, without obscuring the exterior surface of the gas tank to be painted, (ii) a shaft or other rotary device carrying the bung plug adapter for rotating the bung plug adapter and gas tank secured thereto through 360 degrees about an axis that is not restricted to a horizontal position, and a corresponding position-locking mechanism to selectively secure the first shaft and gas tank in a desired angular position about such axis, (iii) a horizontal shaft or other rotary device carrying the first-mentioned shaft for rotating the gas tank through 360 degrees about a horizontal axis, and a corresponding position-locking mechanism to selectively secure the gas tank in a desired angular position about the horizontal axis, and (iv) an optional telescoping post or other linear-motion translating device carrying the horizontal shaft for selective height adjustment of the gas tank.

In a certain preferred embodiment, shown in the drawings, and discussed in further detail below, a portable motorcycle gas tank paint stand, according to the invention, includes a wheeled frame with an upright telescoping post which is rigidly supported by braces on support members of the frame. The upright telescoping post allows for vertical height adjustment and holds a mounted horizontal bracket. This bracket has a machined position-locking device and further holds a horizontal rotation shaft. The rotation shaft has an attached handle at one end and an associated lock release lever, lock pin and return spring arrangement. The handle allows the operator to rotate the shaft through 360 degrees in both a clockwise and counter clockwise direction around a horizontal axis. This enables positioning of the motorcycle gas tank in a desired angular position about the horizontal axis for painting. The lock pin engages a location lock plate secured to the bracket in pre-established angular increments, such as every 45 degrees. When thus locked in position, the operator may let go of the handle, and the rotation shaft and gas tank will remain in a fixed angular position about the horizontal axis. A location lock release lever permits the operator to unlock the rotation shaft and further rotate the shaft about the horizontal axis. On the opposite end of the rotation shaft is a gas tank connecting rod and handle with a lock knob. The connecting rod passes through the rotation shaft at 90 degrees and can be rotated through 360 degrees in both the clockwise and counter clockwise direction about its longitudinal axis. The operator may rotate the gas tank 360 degrees around a vertical axis with the connecting rod positioned downwardly (or upwardly) from the rotation shaft. The connecting rod and gas tank may be locked in a fixed angular position by tightening the connecting rod lock knob, and allowed to rotate by loosening the lock knob. The motorcycle gas tank is attached to the paint stand by inserting a bung holder tightening device with a bung plug adapter or bung holder connected to the end by standard threads into the opening of the motorcycle gas tank where the fuel enters, into the bung. By turning the tightening device clockwise the bung holder attaches to the inside of the gas tank bung. The tightening device is positioned over and secured to the connecting rod by inserting a connecting rod pin. When painting of the gas tank has been completed, the operator may remove the connecting rod pin, place the tank on a stable surface and turn the bung holder tightening device in a counter clockwise direction to loosen the bung holder from the gas tank opening so that it may be removed.

### BRIEF DESCRIPTION OF THE DRAWINGS

FIG. 1 is a perspective view of a preferred embodiment motorcycle gas tank paint stand (40), according to the invention, with a motorcycle gas tank (38) attached.

FIG. 2 is an exploded perspective view of the paint stand (40), with the parts of the stand numbered, and with directional arrows (A, B) showing rotational capabilities of the stand about a horizontal axis (42, via directional arrow A), and a second axis (44, via directional arrow B) that is fixed for rotating with the horizontal axis.

FIG. 3 is a top plan view of the horizontal control handle (17) and locking pin housing (18) with release lever (20) and related parts, with the top cover of the housing broken away for viewing certain parts in the housing, with directional arrow (C) showing movement of the location lock pin (21) and return spring (22), and with directional arrow (D) showing movement of the location lock release lever (20).

FIG. 3A is a rear view of the horizontal control handle (17) and locking pin housing (18) with release lever (20) and related parts shown in FIG. 3.

FIG. 3B is a rear view of the horizontal control handle (17) and locking pin housing (18) with release lever (20) and related parts shown in FIG. 3.

FIG. 4 is a perspective view of the gas tank bung holder tightening device (30).

FIGS. 4A, B and C are side elevation views of three individual styles of bung holders (34, 35 and 36) that may be selectively secured to the bottom of the tightening device shown in FIG. 4.

FIG. 5 is a perspective view of the paint stand (40), with the bung holder tightening device (30), a bung holder (34, 35 or 36), the rotation shaft (15) and horizontal control handle (17) and related parts rotated 45 degrees around the horizontal axis (42). The directional arrow A indicates the further rotational capability of the bung holder tightening device (30) and bung holder (34, 35 or 36) through 360 degrees around the second axis (44) that is now rotated 45 degrees around the horizontal axis (42) as compared with the position of the paint stand shown in FIGS. 1 and 2.

FIG. 6 is a perspective view of the paint stand (40), with the bung holder tightening device (30), a bung holder (34, 35 or 36), the rotation shaft (15) and horizontal control handle (17) and related parts rotated 90 degrees around the horizontal axis (42). The directional arrow A indicates the further rotational capability of the bung holder tightening device (30) and bung holder (34, 35 or 36) through 360 degrees around the second axis (44) that is now rotated 90 degrees around the horizontal axis (42) as compared with the position of the paint stand shown in FIGS. 1 and 2.

FIG. 7 is a perspective view of the paint stand (40), with the bung holder tightening device (30), a bung holder (34, 35 or 36), the rotation shaft (15) and horizontal control handle (17) and related parts rotated 180 around the horizontal axis (42). The directional arrow A indicates the further rotational capability of the bung holder tightening device (30) and bung holder (34, 35 or 36) through 360 degrees around the second axis (44) that is now rotated 180 degrees around the horizontal axis (42) as compared with the position of the paint stand shown in FIGS. 1 and 2.

FIG. 8 is an exploded perspective view of the gas tank bung holder tightening device (30) and the bung holder (36).

FIG. 9 is a view similar to FIG. 1 of an alternate motorcycle gas tank paint stand (50), according to the invention, with a motorcycle gas tank (38) attached.

FIG. 10 is a view similar to FIG. 5 of the alternate motorcycle gas tank paint stand (50) shown in FIG. 9.

FIG. 11 is a fragmentary perspective view of an alternate frame structure (54).

FIG. 12 is a fragmentary perspective view of an alternate holder (70) for the bung plug adapters (34, 35, 36)

FIG. 13 is an exploded fragmentary view of the alternate holder shown in FIG. 12.

The paint stand (40) shown in the drawings includes the following elements described in further detail below:

1A—frame

1—wheels

2—side frame members

3—front frame member

4—center and back frame members, center drilled

4A—center connecting frame member

5—welded support brace

6—bolted support brace

7—attachment bolts for support brace 6

8—attachment bolts for upright post 9

9—upright post

10—telescoping post

11—connecting pin for securing telescoping post 10 to upright post 9

12—square holding bracket, for rotatably supporting rotation shaft 15

13—low-friction thrust washers

14—retaining pin

15—gas tank rotation shaft

16—machined and drilled location lock plate

17—horizontal positioning control handle

18—handle and locking pin housing

19—rotation shaft and handle connecting pin

20—location lock release lever

20A—free end of release lever 20

20B—connected end of release lever 20

21—location lock pin

21A—front free end of lock pin 21

21B—back end of lock pin 21

22—lock pin return spring

23—return spring retainer

24—lock lever attachment bolt

25—movable clevis pin

26—gas tank connecting rod

26A—connecting rod handle

27—connecting rod locking knob

28—connecting rod pin

29—lock collar

30—bung holder tightening device

30C—connected end (top) of bung holder tightening device 30

30B—free end (bottom) of bung holder tightening device 30

30C—threaded hole in free end of bung hole tightening device 30

31—bung holder top washer of expanding bung plug 36

31A—through hole in top washer 31

32—bung holder cylindrical expansion rubber of expanding bung plug 36

32A—center through-hole in expansion rubber 32

33—bung holder bottom tapered washer of expanding bung plug 36

33A—bung holder connector (threaded stem) of tapered washer 33

34—threaded type bung holder

35—wing type bung holder

36—expanding (compression type) bung holder

38—gas tank

40—paint stand

42—horizontal axis of rotation

44—second axis of rotation, fixed for rotation about horizontal axis 42

A—arrow indicating rotation capability of certain parts about the horizontal axis 42

B—arrow indicating rotation capability of certain parts about the second axis 42

C—arrow indicating movement capability of certain parts of the paint stand

D—arrow indicating movement capability of certain parts of the paint stand

While the invention is susceptible of various modifications and alternative constructions, certain illustrated embodiments have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

In general, a preferred embodiment motorcycle gas tank paint stand, according to the invention, includes (i) a frame, (ii) a bung plug adapter or bung holder that releasably connects to the inside diameter wall of the gas fill access opening of a gas tank, and optionally engages the top outer lip surrounding the gas fill access opening, without obscuring the exterior surface of the gas tank to be painted, (iii) a linear-motion mechanism supported by the frame for effecting selective height adjustment of the bung plug adapter and gas tank secured thereto, (iv) a horizontal shaft or other rotary device supported by the linear-motion mechanism for rotating the gas tank through 360 degrees about a horizontal axis, and a corresponding position-locking mechanism to selectively secure the gas tank in a desired angular position about the horizontal axis, and (v) a second shaft or other rotary device that carries the bung plug adapter and is supported by the horizontal shaft (a) for rotation therewith about the horizontal axis, and (b) for independent rotation of the bung plug adapter and gas tank through 360 degrees about a second axis, and a corresponding position-locking mechanism to selectively secure the gas tank in a desired angular position about the second axis.

Turning now descriptively to the drawings, in which similar reference characters denote similar elements throughout the several views:

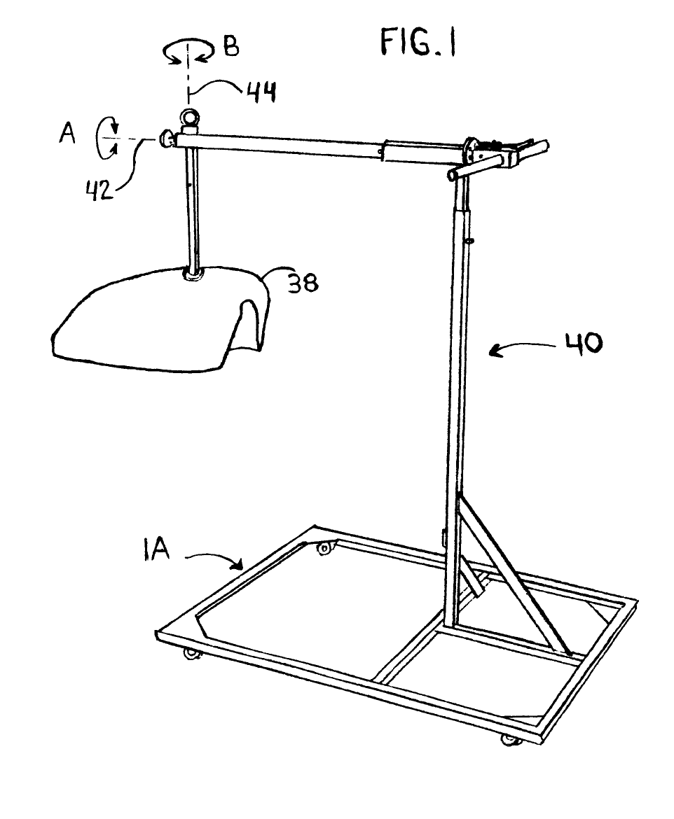

FIG. 1 illustrates one preferred embodiment tank paint stand 40, according to the invention, with a motorcycle gas tank 38 attached for painting, detailing, application of decals, or other decorative, maintenance or repair purposes.

As indicated by directional arrow A, the paint stand is capable of rotating the gas tank through 360 degrees about a horizontal axis 42. As indicated by directional arrow B, the paint stand is further capable of rotating the gas tank through 360 degrees about a second axis 44 that is fixed for rotation about the horizontal axis. In the preferred embodiment shown, the second rotational axis extends orthogonal to the horizontal axis of rotation, such that the second rotational axis rotates in a vertical plane that is, of course, orthogonal to the horizontal axis. The paint stand is shown in FIG. 1 with the second axis secured in a vertical position, extending down from the horizontal axis.

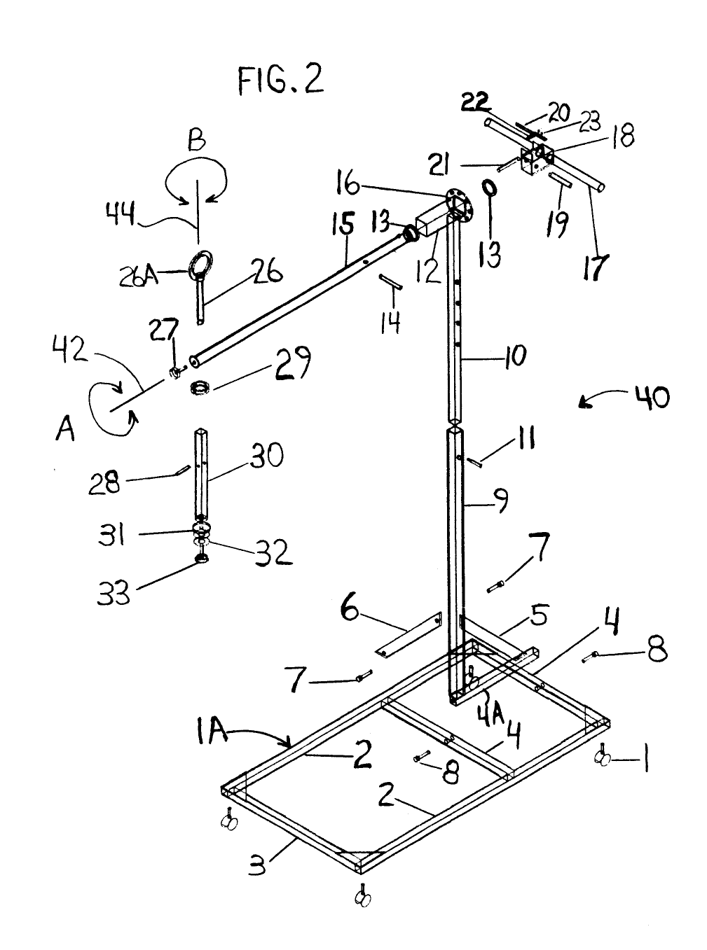

FIG. 2 illustrates the tank paint stand 40 having a rectangular frame 1A established by welding or otherwise connecting frame members 2, 3 and 4 together. This frame is made portable by four wheels 1 connected at the bottom of the frame corners. The frame supports an upright post 9 welded or otherwise secured to frame member 4A connected between the center and back frame members 4 by two attachment bolts 8. The upright post is held rigid and square by a front-to-back support brace 5 and a side-to-side support brace 6. In this instance, support brace 5 is welded between the upright post and the connecting frame member 4A, and support brace 6 is connected between the upright post and the center frame member 4 by two attachment bolts 7. Alternate frames and connections may be utilized in providing a supporting structure for the paint stand.

The upper portion of the upright post 9 telescopically connects to post 10 so that the tank paint stand 40 has vertical height adjustment. In the embodiment shown, the telescoping post 10 is connected by connecting pin 11 to post 9, inserted through aligned holes in opposite sides of post 9 and a selected one of longitudinally spaced holes in post 10. Thus, the height of post 10 is adjusted by placing the connecting pin through the aligned holes in upright post and through one of the selected aligned holes in post 10, for changing the operative height of the paint stand.

A tubular holding bracket 12 is welded or otherwise secured to the top of and at a right angle to post 10 such that the hollow center of the bracket extends horizontally. The bracket holds a gas tank rotation shaft 15 parallel to the ground (i.e., extending longitudinally horizontal), for rotation about horizontal axis 42, and thus permits rotation of the tank holding elements of the stand (discussed further below) and the gas tank to rotate around the horizontal axis.

In this instance, rotation shaft 15 extends through the center of the bracket 12 into a handle and lock pin housing 18. The rotation shaft is held in place at the front end of the bracket by retaining pin 14 inserted through aligned holes in opposite sides of the shaft. The rear end of the rotation shaft is connected to the housing 18 by a rotation shaft and handle connecting pin 19 inserted through aligned holes in opposite sides of the housing and through aligned holes in the shaft. Thus, pins 14 and 19 trap the rotation shaft lengthwise in the bracket. The front end of the bracket and the pin 14, and the back end of the bracket and the front of the housing 18, are separated by low-friction thrust washers 13 that permit smooth rotation of the shaft inside the bracket.

A horizontal positioning control handle 17 is welded or otherwise secured to housing 18, such as extending through aligned holes in opposite sides of the housing in the embodiment shown. When the operator rotates the handle, which can be rotated in both clockwise and counterclockwise directions, the paint stand provides for rotation of the gas tank 38 around the horizontal axis 42 for convenience while painting the tank.

Location lock plate 16 is welded or otherwise secured to the stationary bracket 12, and is provided with angularly spaced horizontal through holes, such as at every 45 degrees, so that location lock pin 21 can enter one of the drilled holes in the plate and lock the horizontal rotation shaft 15 and gas tank in a selected angular position about the horizontal axis 42. Thus, the holes in plate provide established angular spacing or increments for selective rotational positioning of the shaft through 360 degrees of rotation about the horizontal axis. Accordingly, when the handle is used to rotate the shaft around the horizontal axis, the paint stand permits the operator to lock the gas tank 38 into a desired angular position for painting.

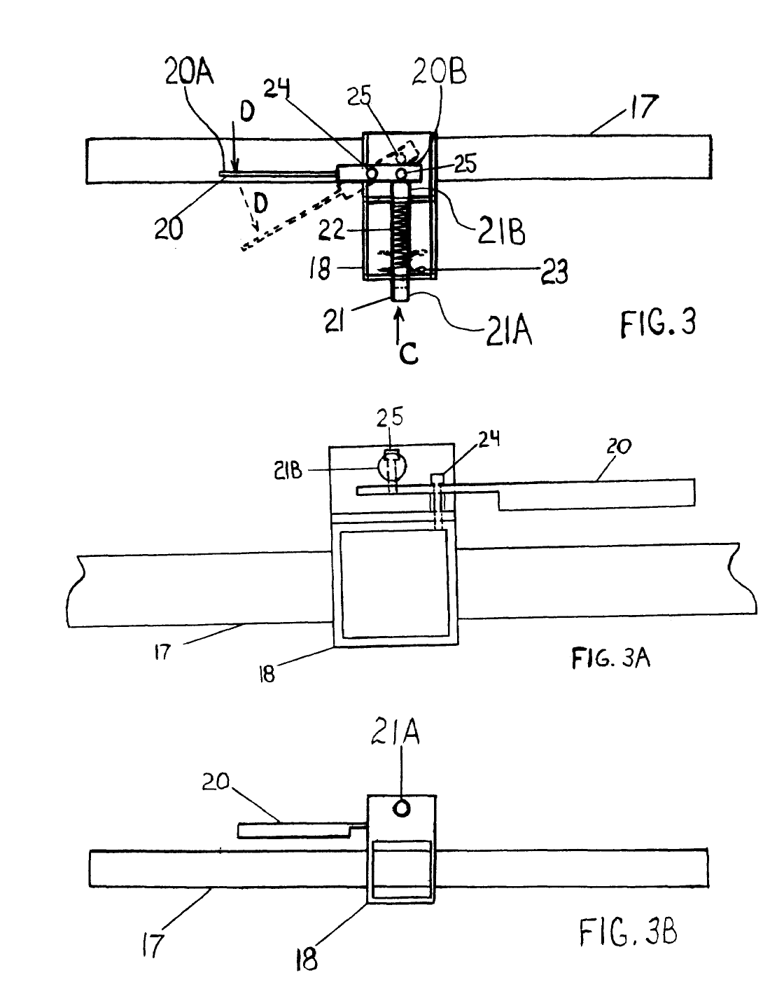

FIG. 3 illustrates further details of the handle 17 and related parts that enable selective rotational positioning of the shaft 15, a bung holder tightening device 30 and a gas tank bung holder (34, 35 and 36) connected thereto about the horizontal axis 42, and thus, enables selective rotational positioning of the gas tank 38 about the horizontal axis.

In this instance, lock release lever 20 is secured to housing 18 by a lock lever attachment bolt 24 for pivoting about the longitudinal, vertical center axis (extending perpendicular to the view shown in FIG. 3, and vertical in the views shown in FIGS. 3A and 3B) of the bolt, and to the back end 21B of the lock pin 21 by a movable clevis pin 25 for relative pivoting therebetween. When the free end 20A of the release lever is pivoted forward (counterclockwise as shown in FIG. 3, and as indicated by the direction of arrow D and the representation of the release lever shown in dashed lines) about the bolt 24, the opposite end 20B of the release lever also pivots counterclockwise about pin 25 to move the lock pin rearwardly (as indicated by direction arrow C). As the lock pin moves rearwardly, the forward end 21A will unlock from the location lock plate 16 (i.e., the free end 21A of the lock pin will be drawn out of a hole in the plate). This movement of release lever and lock pin compresses the lock pin return spring 22 which is contained in the housing 18 between a back plate 18A and a return spring retainer 23. The lock pin is now ready to enter the plate 16 at the next drilled hole when the control handle is further rotated. Thereafter, the lock pin will remain locked into the plate until the release lever is once again pushed forward to unlock the mechanism. The return spring 22 causes a forward spring bias on the lock pin such that, if the release lever is not held forward by the operator, the lock pin will automatically enter the next hole in the plate as the control handle is rotated. If further rotation is desired, the operator simply holds the release lever in its forward position until approaching the desired angular position, after which releasing the lever will allow the lock pin to spring bias into the next hole in the plate that the lock pin aligns with as the control handle is further rotated.

Referring to FIG. 1, the paint stand 40 is shown with the bung holder tightening device 30 locked in position extending vertically down from the end of the rotation shaft 15. As further illustration:

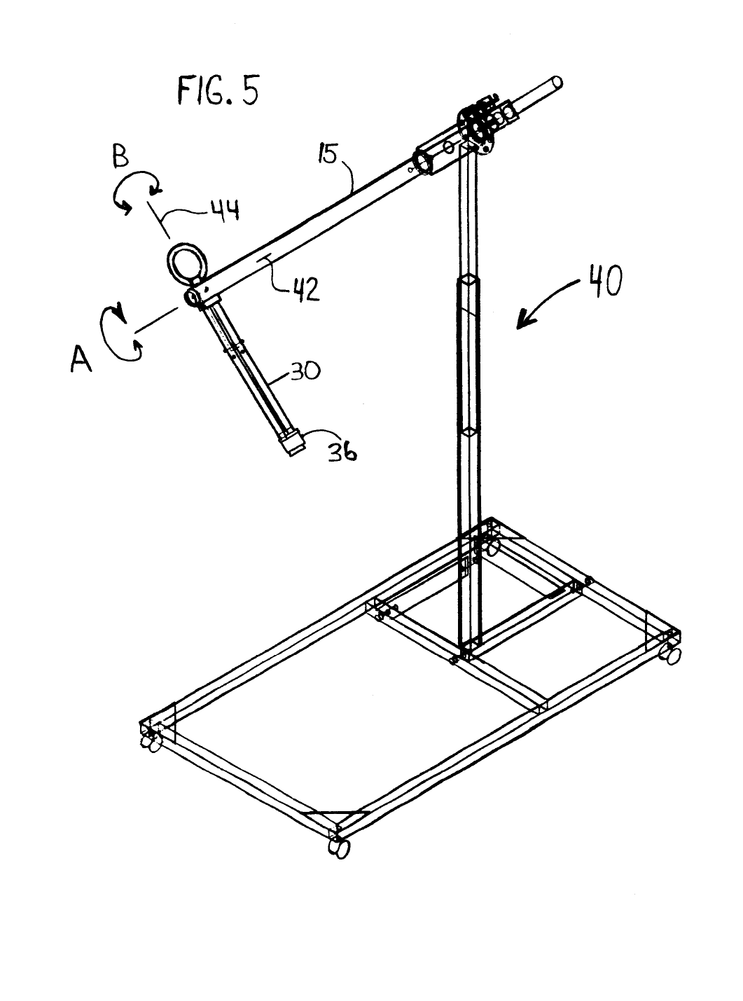

FIG. 5 shows the paint stand 40, with the bung holder tightening device 30, a bung holder 34, 35 or 36, the rotation shaft 15 and handle 17 and related parts rotated and locked in position 45 degrees clockwise (when viewed behind the stand) about the horizontal axis 42, from the position shown in FIG. 1; or in other words, with the bung holder tightening device rotated 45 degrees from the vertical down position shown in FIG. 1 to an angled down position.

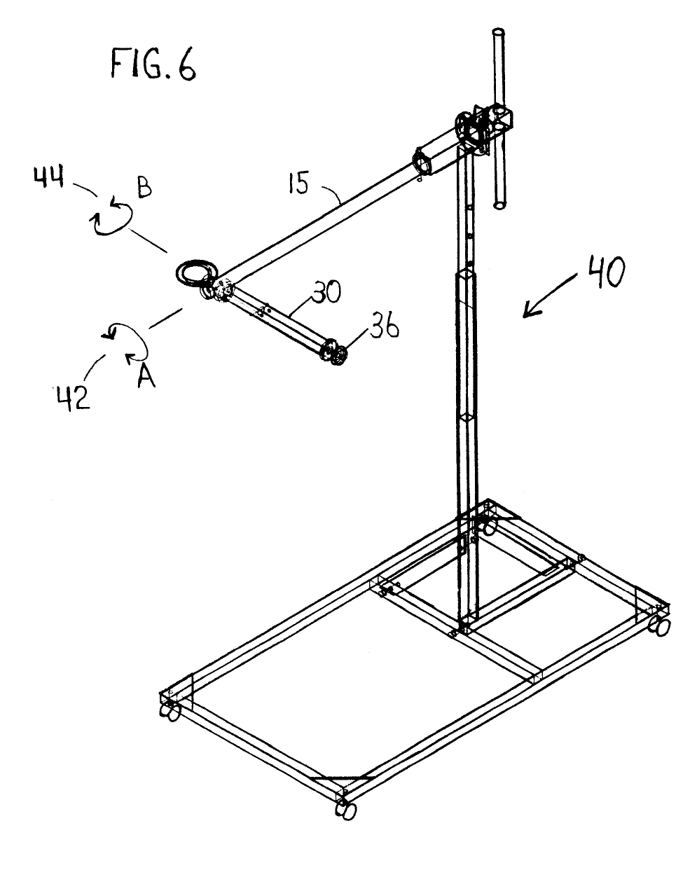

FIG. 6 shows the paint stand 40, with the bung holder tightening device 30, a bung holder 34, 35 or 36, the rotation shaft 15 and handle 17 and related parts rotated and locked in position 90 degrees clockwise, when viewed behind the stand, about the horizontal axis 42, from the position shown in FIG. 1; or in other words, with the bung holder tightening device rotated 90 degrees from the vertical down position shown in FIG. 1 to a horizontal position, extending left when viewed from behind the stand.

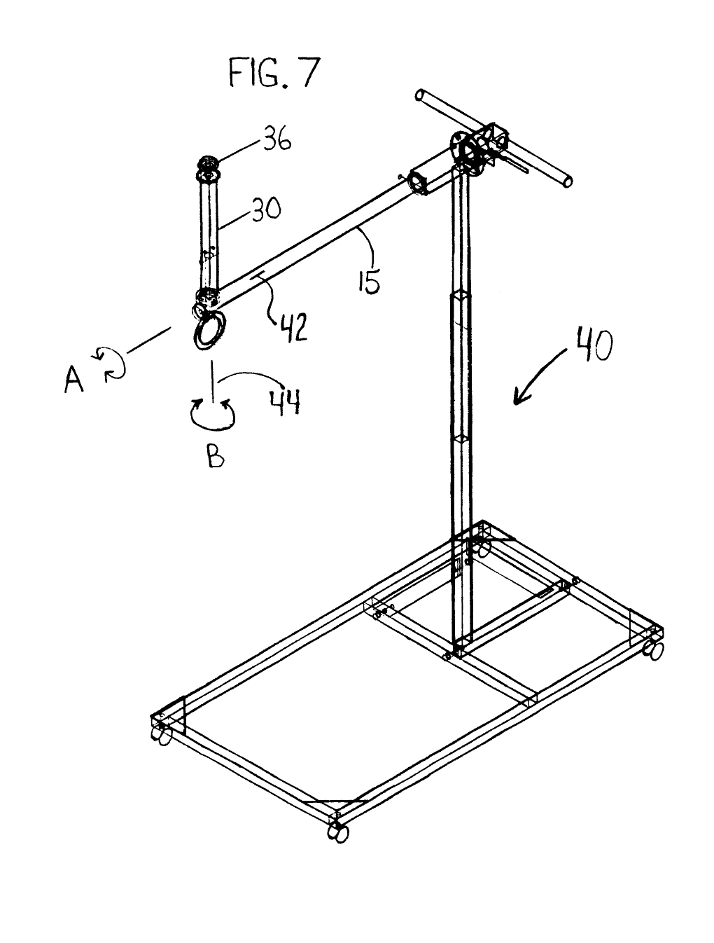

FIG. 7 shows the paint stand 40, with the bung holder tightening device 30, a bung holder 34, 35 or 36, the rotation shaft 15 and handle 17 and related parts rotated and locked in position 180 about the horizontal axis 42 from the position shown in FIG. 1; or in other words, with the bung holder tightening device rotated 180 degrees from the vertical down position shown in FIG. 1 to a vertical up position.

In FIGS. 1 and 5-7, the direction arrow A indicates the rotational capability of the bung holder tightening device 30, a bung holder 34, 35 or 36, the rotational shaft 15 and the handle 17 and related parts through 360 degrees around the horizontal axis 42. The direction arrow B indicates the rotational capability of the bung holder tightening device and a bung holder through 360 degrees around a second axis extending longitudinally through the bung holder tightening device, and that is therefore fixed for rotation about the horizontal axis.

FIG. 2 further illustrates a holding device in the form of a compression style bung holder 36 for holding the motorcycle gas tank 38, and elements of the paint stand 40 that enable rotation of the gas tank about the second axis 44 that is fixed to rotate as the rotational shaft rotates about the horizontal axis 42. In the preferred embodiment shown, the second axis is orthogonal to the horizontal axis, for rotation in a vertical plane about the horizontal axis. In the position shown in FIGS. 1-2, the second axis is nominally a vertical axis, with the handle 17 in its horizontal position.

As shown, a gas tank connecting rod 26, provided with a handle 26A, is rotatably carried at the free end of rotation shaft 15, passing through top and bottom aligned holes, to extend perpendicular to control handle 17. A lower shoulder on the handle 26A or connecting rod prevents the connecting rod and handle from falling through the aligned holes in the rotation shaft, and the lower end of the connecting rod is secured to the shaft by a lock collar 29, such that the connecting rod may be manually rotated through 360 degrees around the longitudinal center axis of the connecting rod (a vertical axis in the position shown) by turning by handle 26A. The bung holder tightening device 30 is secured to the connecting rod for rotation therewith with connecting rod pin 28 installed through aligned holes in the bung holder tightening device and the connecting rod. The lower end of the bung holder tightening device, in turn, carries a bung holder or bung plug adapter (34, 35 or 36) that releasably connects to the gas fill access opening of the gas tank. As a result, the painter can manually rotate the gas tank about the horizontal axis 42 for painting the tank, as well as manually rotate the tank into any desired rotational position about the vertical axis 44 for painting, and optionally lock the gas tank into such position by, for example, utilizing a connecting rod lock knob 27 and threaded stud that threads into the free end of the rotation shaft for tightening the end of the stud against the connecting rod. Thus, the knob 27 may, for example, be turned clockwise to lock the connecting rod 26, the bung holder tightening device, the bung holder and the gas tank into the desired rotation position about the vertical axis, or turned counterclockwise to allow the connecting rod, the bung holder tightening device, the bung holder and the gas tank to rotate freely about the vertical axis.

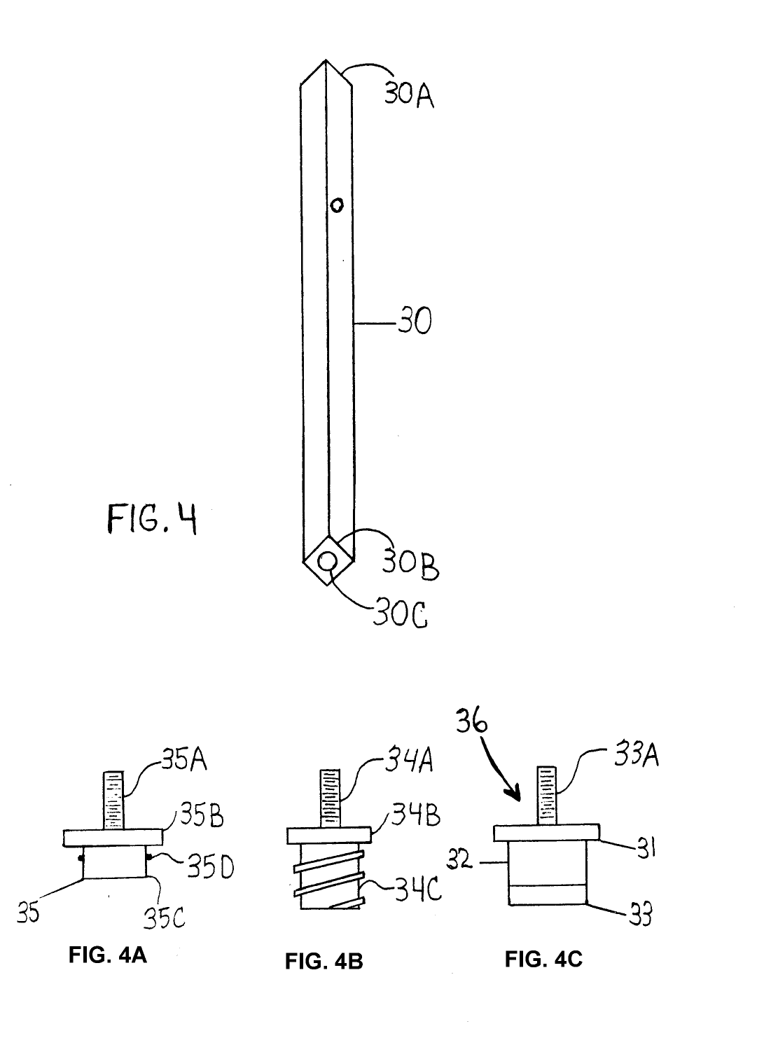

Three types of bung holders are shown in the drawings, and discussed in further detail below: a compression style, or expanding bung holder 36 (FIG. 4C), a threaded bung holder 34 (FIG. 4B), and a bayonet or wing style bung holder 35 (FIG. 4A).

The unique method for holding a gas tank 38 with the paint stand 40 allows the painter to access and paint all exposed or visible surfaces of the gas tank. In the preferred embodiment shown, the gas tank holding method is accomplished by one of three unique methods.

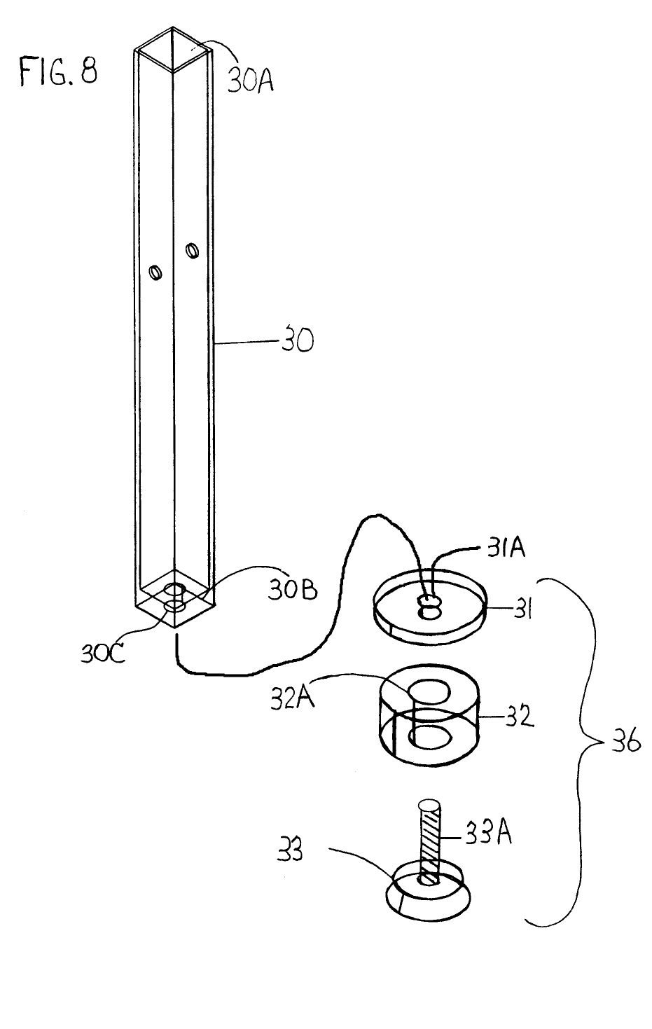

The first and most versatile method involves use of the expanding bung holder 36. As shown in FIGS. 4 and 4C, and in an exploded perspective view in FIG. 8, this method utilizes three parts in the expanding bung plug assembly: a cylindrical expansion rubber 32, a top washer 31 seated on the top of the expansion rubber, and a tapered washer 33 seated on the bottom of the expansion rubber. The tapered washer includes a threaded stem 33A that extends upwards through a center through-hole 32A in the expansion rubber, through a hole 31A in the top washer, and past the top of the top washer for threading into the threaded hole 30C in the bottom of the bung holder tightening device 30.

To use the expanding bung plug holder 36, the threaded stem 33A of the assembled expanding holder 36 is initially threaded into the hole 30C of the tightening device 30 until the top washer 31 is snug against the bottom of the tightening device. The bung plug adapter is then installed into the gas fill access hole in the gas tank to align the expansion rubber 32 with the inside diameter surrounding wall of gas fill access hole. The threaded stem of the assembled bung plug adapter is then further tightened into the hole 30C of the tightening device, to further tighten the top of the washer 31 against the bottom of the tightening device 30, by holding the gas tank and turning the tightening device. Rotating the tightening device onto the plug draws the tapered washer 33 towards the top washer (i.e., tightens the tapered washer, the expansion rubber, and the top washer together), compressing the expansion rubber and causing it to expand against and resiliently grip the wall surrounding the gas fill access hole for securely holding the tank from the inside of the gas fill access hole. The tightening device, with the bung holder and gas tank secured thereto, is then connected to the connecting rod 26 of the paint stand 40 with the connecting rod pin 28 for positioning and painting of the gas tank. To remove the gas tank from the paint stand, the tightening device is removed from the connecting rod, the gas tank is placed on, for example, a work table, and the tightening device rotated in the opposite direction, again while holding the tank, causing the tapered washer to move away from the top washer and decompressing the expansion rubber, thereby releasing the tank from the expanding plug. Thus, releasing the tank from the stand simply involves a reversed procedure of removing the tightening device, unthreading the tightening device from the expanding bung plug holder, and slipping the bung plug holder from the gas tank. With this arrangement, the expanding bung plug holder may be used with gas tanks having many different configuration gas fill access holes. So long as the expansion rubber can expand to a state of gripping compression against the inside diameter wall surrounding the hole, the expanding bung plug holder can hold the gas tank on the paint stand. Thus, the expanding bung plug holder is simply secured into the gas fill assess hole and to the paint stand utilizing the tightening device to safely, quickly and conveniently secure the tank to the stand.

To assist in properly locating the expansion plug 32 in the gas fill access opening of the gas tank 38, while not restricting access to surfaces of the gas tank to be painted, the top washer 31 is larger in diameter than the opening size of the gas fill access opening, but not larger in diameter than the unpainted lip that surrounds the top of the access opening and is normally covered by the cap of the gas tank. This enables the operator to simply slide the expanding bung plug holder 36 into the gas fill access opening until the bottom of the washer 31 engages the lip of the tank surrounding the gas fill access opening, resulting in automatic alignment of the expansion rubber with the wall surrounding the gas fill access opening. Advantageously, the tapered configuration of the preferred bottom washer 33, angled inwardly from the bottom of the washer towards the expansion rubber, assists in driving the outer cylindrical surface of the expansion rubber into compression gripping engagement with the gas fill access hole. To further assist in expansion of the rubber cylinder, the top washer may be optionally provided with a similar taper, angled inwardly from an upper shoulder on the top washer towards the expansion rubber, the upper shoulder being sized for engaging the top of the tank as described above.

It should be noted that, in the preceding description of the expanding bung plug holder 36, and the following description of the threaded bung plug holder 34 and the winged bung plug holder 35, as well as throughout this description of the invention, those skilled in the art will appreciate and recognize that, where components or elements are specified or will be understood as engaging or contacting one another, the same may be accomplished by specifying mating surfaces, such as, but not limited to shoulders, on or operatively connected to the specified components or elements. Thus, for example, where the threaded stem 33A is noted above as threaded into the hole 30C until the top washer 31 is drawn tightly against the bottom of the tightening device 30, it will be understood that the same can be accomplished by threading the stem into the hole until an upwardly facing surface (such as but not limited to a shoulder) on or operatively connected to the top washer is drawn tightly against a downwardly facing surface (such as but not limited to a shoulder) on or operatively connected to the bottom of the tightening device. Similarly, for example, where it is noted above that the bottom of the washer 31 engages the top of the gas tank 38 surrounding the gas fill access hole, it will be understood that the same can be accomplished by specifying a downwardly facing surface (such as but not limited to a shoulder) on or operatively connected to the washer 31 that engages an upwardly facing surface (such as but not limited to a shoulder) on or operatively connected to the gas tank.

Thus, in a variation of the above, the expanding bung plug holder 36 can be modified to include a threaded element, such as a conventional or special-configuration threaded nut, that can be threaded onto the stem 33A of the assembled bung plug holder to engage the top washer 31 hold the bung plug holder together without the tightening device 30. This would enable, for example, initial placement of the bung plug holder into the gas fill access opening of the gas tank, and optional compression of the cylindrical expansion rubber 32 in the gas fill access hole to secure the bung plug holder therein, prior to threading the tightening device 30 onto the bung plug holder. In this instance, the top of the additional nut provides the upwardly facing shoulder operatively connected to the top washer for engaging the bottom of the tightening device to further compress the expansion rubber as the plug and tightening device are threaded together.

The second method shown for holding a gas tank 38 involves use of the threaded bung attachment 34 (FIG. 4B) for holding gas tanks with a threaded gas fill access hole. As shown in FIG. 4, the threaded bung plug holder includes an upper threaded stem 34A, a center washer element 34B, and a lower threaded segment 34C. The threaded stem 34A threads into the threaded hole 30C in the bottom of the tightening device 30, the threaded segment 34C threads into the internally threaded gas fill access opening of the gas tank, and the washer element 34B is sized to engage (i) the top lip of the gas tank surrounding the gas fill access opening and (ii) the bottom of the tightening device.

To use the threaded bung plug holder 34, the threaded segment 34C is tightened into the gas fill access opening in the gas tank 38 (until the washer element 34B snugly engages the top lip surrounding the gas fill access opening), and the threaded stem 34A is threaded tightly into the hole 30C of the tightening device 30 (until the washer element 34B snugly engages the bottom of the tightening device). Thus, the threaded bung plug holder is simply secured into the gas fill assess hole and to the paint stand 40 to safely, quickly and conveniently secure the tank to the stand. And releasing the tank from the stand simply involves a reversed procedure, removing the tightening device from the paint stand, and unthreading the threaded bung plug holder from the tightening device and from the gas tank.

The third method shown for holding a gas tank 38 involves use of the winged type bung attachment 35 (FIG. 4C) for holding gas tanks with a bayonet type gas fill access hole. As shown in FIG. 4, the winged bung plug holder includes an upper threaded stem 35A, a center washer element 35B, and a lower segment 35C with two opposing tabs or wings 35D that extend outwardly from the surface of the lower segment. The threaded stem 35A threads into the threaded hole 30C in the bottom of the tightening device 30, the wings 35D rotate into opposing slots formed in a gas fill access opening with a bayonet type connection for the gas tank cap, and the washer element 35B is sized to engage (i) the top lip surrounding the gas fill access opening and (ii) the bottom of the tightening device.

Thus, to use the winged bung plug holder 35, the threaded stem 35A is threaded tightly into the hole 30C of the tightening device 30 (until the washer element 35B snugly engages the bottom of the tightening device), and the lower winged segment 35C is then rotated tightly into the gas fill access opening in the gas tank (until the washer element 35B snugly engages the top lip surrounding the gas fill access opening). Thus, the winged bung plug holder is simply secured into the gas fill assess hole and to the paint stand 40 to safely, quickly and conveniently secure the tank to the stand. And releasing the tank from the stand simply involves a reversed procedure, removing the tightening device from the paint stand, and unthreading the winged bung plug holder from the tightening device and twisting the winged bung plug holder from the gas tank.

These methods, and operatively equivalent methods that those skilled in the art will devise within the scope of the invention, in view of the teachings hereof, for holding a motorcycle gas tank, namely providing a bung plug holder that is simply secured into the gas fill assess hole and to the paint stand to secure the tank to the stand, are unique in that all surfaces of a gas tank are easily accessible to the painter. To this end, the above-described procedures involve first securing the tightening device and bung plug adapter together, then securing the bung plug adapter into the gas fill access opening in the gas tank, and then securing the tightening device (with the bung plug adapter and gas tank secured thereto) to the connecting rod. However, it should be noted that that although this is the preferred procedure, the connecting rod, the tightening device, the bung plug adapter, and the gas tank may be secured in an alternate sequence, as desired for particular circumstances. And provision of dual-axis rotational capabilities of the paint stand to rotate the motorcycle gas tank on multiple axes, including alternate configurations those skilled in the art will devise for effecting such dual-axis rotational capabilities and which are contemplated by and included within the scope of the invention, in view of the teachings hereof, coupled with the unique method of holding the tanks through the previously described bung devices, creates the ability for painting and detailing all exterior surfaces, as well as performing any other desired operation of the exterior surfaces of a gas tank, without the need to physically touch the gas tank once secured to the stand.

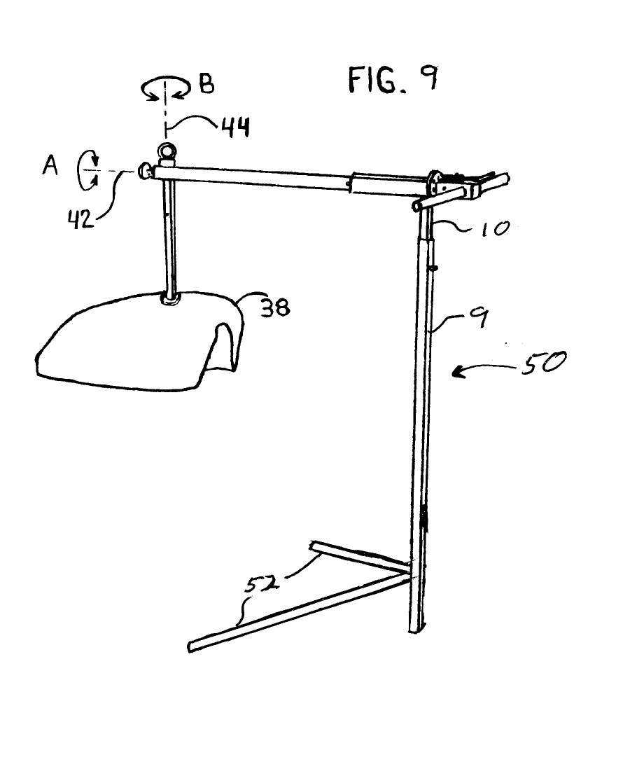

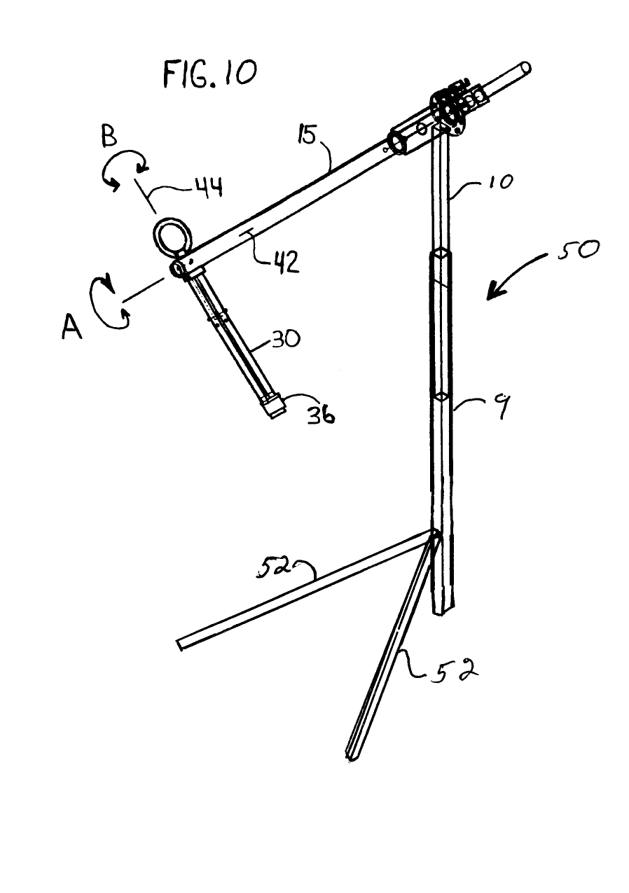

An alternate embodiment motorcycle gas tank paint stand 50 is shown in FIGS. 9 and 10. The paint stand 50 is similar in construction and operation as paint stand 40, except that a simplified frame is provided in the form of two legs 52 that extend at a compound angle from the upright post 9 in a type of tri-pod or three-point support for the gas tank.

FIG. 11 is a perspective view of an alternate wheeled frame structure (54), with a base frame including side frame members 56 and cross frame members 58 connected together. In this instance, the telescoping post 10 is secured at a selected height in the upright 9 with a threaded knob 60 that turns a threaded stud threaded through plate 62 (secured to the upright) the free end of which is secured against the side of the post 10.

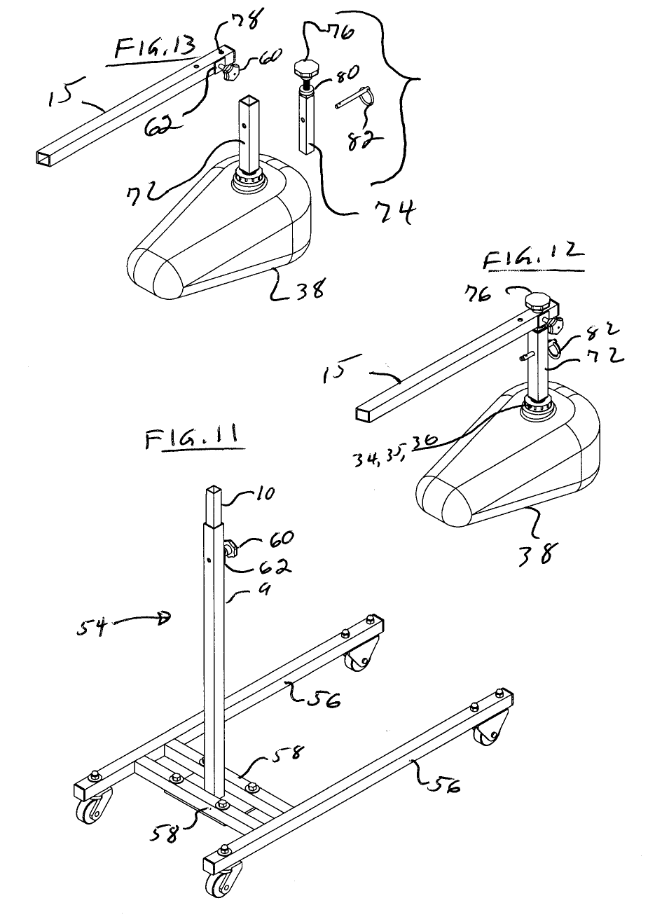

FIGS. 12 and 13 show details of an alternate holder 70 for the bung plug adapters 34, 35, 36. In this instance, the holder includes an outer sleeve 72 and an inner rod 74. The outer sleeve has 72 an open upper end and a lower end with a threaded hole into which the upper threaded stem 34A, 35A, 36A of the bung plug adapters may be screwed to tighten the bung plug adapters thereto. The inner rod 74 is secured to the end of the shaft 15 with a threaded knob 76 that slips through clearance holes 78 in the shaft and is threaded into the upper end of the inner rod to draw the inner rod and a thrust washer 80 into snug engagement with the shaft 15. To secure the gas tank 38 to the shaft 15, the upper end of the sleeve slides around the lower end of the inner rod and is secured in position to the inner rod with a quick release slid-through pin 82. Free rotation of the gas tank about the longitudinal axis of the holder may be prevented by tightening the threaded knob 60 through the plate 62 and into the side of the threaded length of the knob 76.

From the foregoing, it will be apparent that the present invention brings to the art a new, improved and unique paint stand for motorcycle gas tanks that achieves the above identified and other objectives and advantages that will be understood by those skilled in the art.

I claim:

1. A paint stand for motorcycle gas tanks comprising:
a) a frame
b) a vertically adjustable post supported by the frame,
c) a horizontal beam carried by the post for vertical adjustment therewith and for rotation through 360 degrees about a horizontal axis,
d) means to secure the beam in a desired angular position about the horizontal axis,
e) a shaft carried by the beam for rotation through 360 degrees about a vertical axis and for rotation with the beam, including rotation of the vertical axis, about the horizontal axis,
f) means to secure the shaft in a desired angular position about the vertical axis, and
g) a bung plug adapter releasably carried by the shaft for rotation therewith about the vertical axis and swinging about the horizontal axis, the bung plug adapter being configured to releasably connect to the inside diameter wall of the gas fill access opening of a gas tank.

2. The paint stand as described in claim 1, wherein the bung plug adapter engages the top outer lip surrounding the gas fill access opening of the motorcycle gas tank without obscuring the exterior surface of the gas tank to be painted.

3. A paint stand for motorcycle gas tanks comprising
a) a bung plug adapter configured to releasably connect to the cylindrical inside diameter wall surrounding the gas fill access opening of the gas tank,
b) a shaft carrying the bung plug adapter for rotation thereof through 360 degrees about a first axis that is not restricted to a horizontal position,
c) means to secure the shaft in a desired angular position about the first axis,
d) a horizontal beam carrying the shaft for rotation thereof through 360 degrees about a horizontal axis,
e) means to secure the beam in a desired angular position about the horizontal axis.

4. The paint stand as described in claim 3 further comprising means for adjusting the height of the beam.

5. A paint stand for motorcycle gas tanks comprising:
a) a wheeled frame,
b) an upright telescoping post rigidly supported by the frame,
c) a mounting bracket carried by the telescoping post,
d) a beam supported in the bracket for rotation about a horizontal axis,
e) a handle secured at one end of the beam to facilitate manual rotation of the beam through 360 degrees in both clockwise and counterclockwise directions around a horizontal axis,
f) a position-locking device carried in the bracket, the position-locking device being configured to lock the beam in a desired angular position about the horizontal axis, the position locking device including:
i) a lock plate with angular increments, the lock plate being secured to the beam for rotation therewith,
ii) a lock pin for selectively engaging said increments and locking the beam in a corresponding rotational position, said lock pin being spring biased towards engagement with said increments,
iii) means for manually disengaging the lock pin from the increments to enable rotation of the beam about the horizontal axis,
g) a shaft carried at the opposite end of the beam for rotation about a second axis orthogonal to the horizontal axis,
h) means for manually rotating the shaft about the second axis,
i) means for manually securing the shaft in a desired angular position about the second axis,
j) a bung plug adapter connected to the end of the shaft and configured for installation into the gas fill access opening of a gas tank, and
k) means for securing and releasing the plug adapter to and from the gas fill access opening of the gas tank.
